(19) United States
(12) Patent Application Publication
(10) Pub. No.: US 2009/0014079 A1
(43) Pub. Date: Jan. 15, 2009

(54) IN-PUMP GRAY WATER BYPASS SYSTEM

(76) Inventor: Lannie L. STEGALL, Lexington, KY (US)

Correspondence Address: HARNESS, DICKEY & PIERCE, P.L.C., P.O. BOX 8910, RESTON, VA, 20195, US

(21) Appl. No.: 12/138,138

(22) Filed: Jun. 12, 2008

Related U.S. Application Data
(60) Provisional application No. 60/934,301, filed on Jun. 12, 2007.

(51) Int. Cl. B60R 15/00

(52) U.S. Cl. 137/899; 137/1

(57) ABSTRACT

Embodiments of the present invention relate to adapting an existing macerating pump to allow fluid arriving at the inlet side of the pump to travel to the discharge port of the pump without requiring the pump to be operating. In particular, a passageway is made from the inlet port to the discharge port which bypasses the impeller portion of the pump. In this way, fluids and slurries may pass through the pump even though the pump is turned off.

### CROSS-REFERENCE TO RELATED APPLICATIONS

This application claims priority to U.S. Provisional Patent Application No. 60/934,301 filed 12 Jun. 2007, which application is herein expressly incorporated by reference.

### FIELD

The present disclosure generally relates to a wastewater disposal system. More particularly, the present disclosure relates to a gray water bypass system and method.

### BACKGROUND

Recreational vehicles, which include a variety of motor homes, travel trailers and campers, are widely used and provide short-term or long-term living quarters. In this regard, a conventional recreational vehicle (RV) or caravan typically includes indoor plumbing, which includes a sink, a bathtub or shower and/or a toilet. Larger RVs typically include multiple sinks, showers and toilets, and can produce several gallons of wastewater per day. The wastewater is typically stored on-board the vehicle and disposed of periodically.

Various systems for the drainage of wastewater from a vehicle are known. One such system is shown and described in commonly assigned U.S. Pat. No. 6,352,088. U.S. Pat. No. 6,352,088 is incorporated by reference as if fully set forth herein.

The wastewater in an RV is commonly referred to as either gray water or black water. The gray water is the discharge from the kitchen sink, dish washing water and water from the bathroom sink and shower. The black water is the water and waste from the toilet. Generally, the black water and gray water are stored separately in a black water tank and a gray water tank, respectively, but can discharge from a common discharge pipe connecting the tanks.

More specifically, the black water tank and gray water tank are connected by a “Y” connection having a common discharge end. Each tank includes a valve leading to the “Y” connection so that the tanks can be drained individually. Conventional drainage systems include a single flexible drainage hose that is temporarily connected to the end of the discharge pipe by the RV user for draining the wastewater to a sewer or other storage device. Conventional systems rely on gravity, such that if either tank is opened, the volume in the tank empties out the gravity fed system to the sewer. In an attempt to keep the flexible hose clean, the black water tank is typically drained first followed by the gray water tank. This method appears simple, but may often be messy and unsanitary. For example, the flexible drainage hose can slip off the underground sewage line causing wastewater to spill out on the ground. Even worse, the drainage hose can slip off the drainage pipe and spill raw sewage into a compartment in the RV or on the RV user. If the RV user avoids either of these scenarios, however, the end of a conventional hose remains open, such that after the draining process remnants of the wastewater can drip out of the end of the hose and come in contact with the RV or RV user.

In addition, the RV user must endure the rather unsanitary process of removing and rinsing the drainage hose, such as by using a fresh water hose, and then placing the drainage hose back into the storage compartment where it is kept for future use. This is often avoided by the RV user for obvious sanitary reasons. Under the gravity fed conventional system, the total time required to empty the tanks and rinse the hose and tanks from inside the RV is approximately 25-35 minutes. This process must be repeated two to three times weekly for an average use.

A well-known problem in the RV industry is the clogging of the black water tank and the discharge pipe leading from the black water tank due to solids and other matter becoming clogging in the tank, which results in periodic replacement of the black water tank or extremely unsanitary maintenance and repair of the tank. A major contributor to this problem is in the flushing of the RV toilet, which is different than the flushing of a conventional toilet in that only a small fraction of water is used to flush the toilet compared to a conventional toilet. This is done to conserve fresh water and to limit the volume taken in the black water tank. Because of this, the black water tank has a higher concentration of solid matter, which often leads to clogging the black water tank when emptying the tank. The only way to introduce water to the black water tank is to flush the commode manually as described above, or attach a water hose to a black water tank intake port, which may be either provided by the manufacturer or installed by the RV user. Obviously, this requires fresh water, either from the RV fresh water tank or an outside source, which is very wasteful and time consuming.

In addition, it is also known that detergents and surfactants can help break up clogs in the black water tanks. A conventional method to obtain the benefits of detergents and surfactants is to wash dishes in a bucket in the kitchen, and then dump the bucket into the commode to furnish a rinse having detergents and surfactants, which also conserves space in the gray water tank. Due to the tedious steps of hooking up a fresh water hose or taking the time to stand on the flush valve of the commode in order to introduce water to the black water tank, most RV users don't take time to rinse the black water tank. Thus, the black water tank will settle with solids and cause blockage in the discharge pipe will have to be replaced or repaired, often at great expense.

Another problem with conventional RV disposal systems is the frequency at which the storage tanks must be discharged. Typically, the gray water tank and the black water tank hold the same volume, such as 45 gallons each. The amount of gray water produced is must greater than the black water in common usage. For example, two people typically produce 15 gallons of gray water daily, while black water production is only about 3 gallons per day. Accordingly, a large portion of the space in the black water tank goes unused since there is not currently a crossover to the two tanks due to plumbing codes and the design of conventional plumbing systems.

It is desirable to dispose of gray water in a way that does not require operating the macerating pump in an RV's wastewater disposal system. In this way, the noise, expense, wear-and-tear and trouble of always having to turn on the macerating pump to simply dispose of gray water can be avoided. Because there are occasionally solids that travel through the gray water system, it is desirable that the method and system be self-cleaning.

The present teachings generally relate to adapting an existing macerating pump to allow fluid arriving at the inlet side of the pump to travel to the discharge port of the pump without requiring the pump to be operating. In particular a passage way is made from the inlet port to the discharge port which bypasses the impeller portion of the pump. In this way, fluids and slurries may pass through the pump even though the pump is turned off.

Various aspects of the present teachings will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### SUMMARY

According to one particular aspect, the present teachings provide a macerator pump for a wastewater disposal system of a vehicle. The macerator pump includes a housing, an input port and an output port. A primary fluid path extends between the input port and the output port. The primary fluid path includes an impeller region having an impeller driven by a motor. The primary fluid path is open when the motor is on and closed when the motor is off. An ancillary fluid path extends between the input port and the output port. The ancillary fluid path is open independent of an operational state of the motor.

According to another particular aspect, the present teachings provide a wastewater disposal system for a vehicle. The wastewater disposal system includes a black water tank, a gray water tank, and a macerator pump. The macerator pump includes a housing, an input port and an output port. The input port is in fluid communication with the black water tank and the gray water tank. The macerator pump defines a primary fluid path and an ancillary fluid path. The primary fluid path extends between the input port and the output port and includes an impeller region having an impeller driven by a motor. The primary fluid path is open when the motor is on and closed when the motor is off. The ancillary fluid path extends between the input port and the output port. The ancillary fluid path is open independent of an operational state of the motor. A first valve selectively controls the flow of gray water from the gray water tank to the input port of the macerator pump. A second valve selectively controls the flow of black water from the gray water tank to the input port of the macerator pump.

According to yet another particular aspect, the present teachings provide a method of disposing wastewater from a vehicle having a gray water tank and a black water tank. The method includes providing a macerator pump having a housing, an input port and an output port. The input port is in fluid communication with the black water tank and the gray water tank. The macerator pump defines a primary fluid path extending between the input port and the output port and including an impeller region having an impeller driven by a motor. The primary fluid path is open when the motor is on and closed when the motor is off. The method further includes adapting the macerator pump to include an ancillary fluid path between the input port and the output port. The ancillary fluid path is continually open independent of an operational state of the motor. The method further includes selectively controlling the flow of gray water from the gray water tank to the input port to discharge gray water through the ancillary fluid path when the motor is off.

Further areas of applicability of the present teachings will become apparent from the description provided hereinafter. It should be understood that the description and specific examples are intended for purposes of illustration only and are not intended to limit the scope of the present teachings.

### BRIEF DESCRIPTION OF THE DRAWINGS

The drawings described herein are for illustration purposes only and are not intended to limit the scope of the present disclosure in any way.

FIG. 1 illustrates a prior art RV wastewater disposed system.

FIG. 2 illustrates a wastewater disposal system according to the present teachings.

FIG. 3 is an exploded view of a macerating pump adapted according to the teachings.

FIG. 4 is a perspective view of another macerating pump according to the present teachings.

FIG. 4B is an end view of the macerating pump of FIG. 4A.

FIG. 5 is an exploded view of yet another macerating pump according to the present teachings.

### DESCRIPTION OF VARIOUS ASPECTS

The following description is merely exemplary in nature and is not intended to limit the present disclosure, application, or uses. It should be understood that throughout the drawings, corresponding reference numerals indicate like or corresponding parts and features.

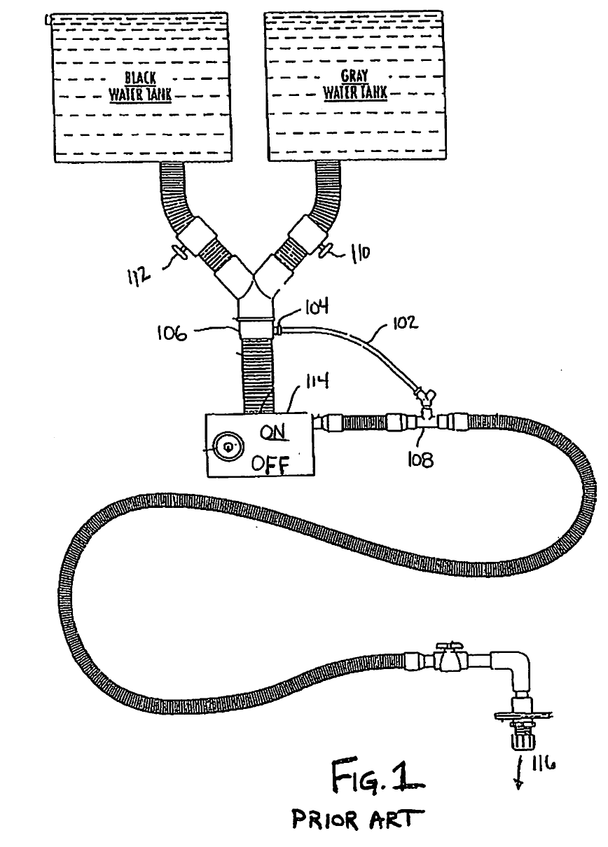

With initial reference to FIG. 1, the wastewater disposal system more fully described in U.S. Pat. No. 6,352,088 is illustrated. In this system, black water and/or gray water may be discharged through a pump 114 and out a spigot 116. Valves 112, 110 selectively permit wastewater from the tanks to be delivered to the pump 114. An adapter 106 has a port 104 that connects to flexible tubing 102. This flexible tubing 102 connects at its other end to an adapter 108.

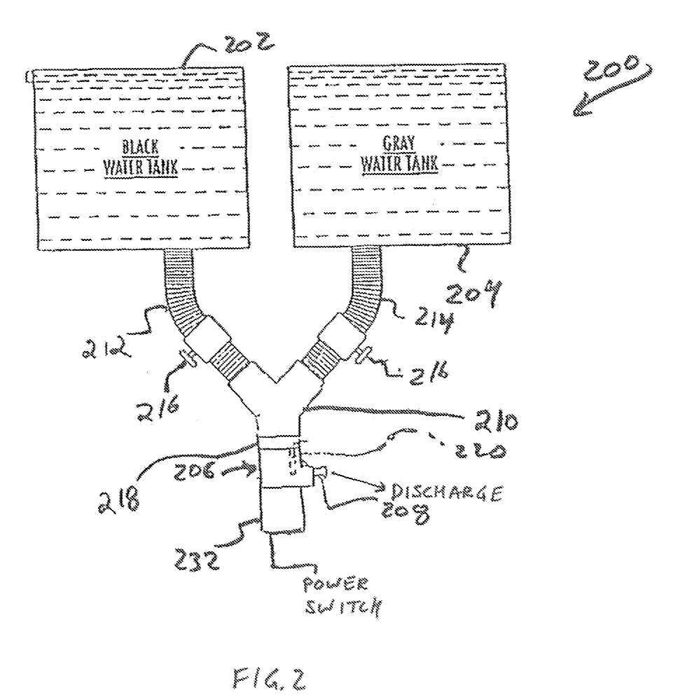

Turning now to FIGS. 2-4, a wastewater disposal system in accordance with the present teachings is generally identical at reference character 200. The wastewater disposal system 200 is illustrated in to generally include the black and gray water tanks 202 and 204 of a vehicle and a macerator pump 206. The black and gray water tanks 202 and 204 will be understood to be conventional. In discussing the system 200, “upstream” will be considered to be in the direction towards the tanks 202 and 204 and “downstream” will be considered to be in the direction towards a discharge port 208 of the pump 206.

The black water and gray water tanks 202 and 204 may be connected by a “Y” connection 210 or other coupling having a common discharge end. In this regard, a first conduit 212 connects the black water tank 202 to the coupling 210. A second fluid conduit 214 connects the gray water tank 204 and the conduit 210. Both conduits 212 and 214 may be associated with a valve 216 for selectively allowing flow therethrough. The coupling 210 may join the pump 206 at an adapter 218. One of ordinary skill will recognize that there are a variety of functionally equivalent coupling adapters 218 that may be employed without departing from the scope of the present invention.

In a conventional pump, no flow occurs between the inlet portion of the pump and the discharge port when the pump is turned off. The present teachings provide an ancillary path 220 is provided between the inlet portion and the discharge port 208 that allows flow to occur even with the pump off. In this regard, the valve 216 associated with the conduit 214 may be opened to allow gray water to flow from the tank 204 downstream towards the pump 206. The gray water first flows into the Y-connector 210 that is also coupled to the black water tank 202. Once the gray water reaches the pump 206 it is prevented from flowing anywhere except through the ancillary path 220 that is provided in the pump housing. Through this ancillary path 220, the gray water reaches the discharge port 208 and may be expelled from the pump 206.

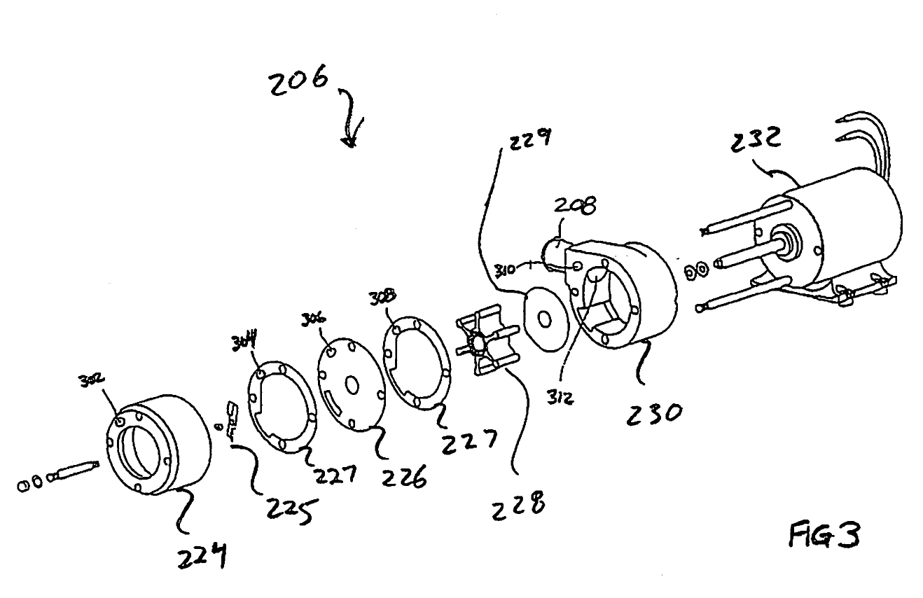

With particular reference to the exploded view of FIG. 3, the various components of a pump 206 adapted according to the present teachings is illustrated. It will be understood that the pump 206 illustrated is merely one exemplary pump that may be adapted in accordance with the principles of the present teachings. The pump 206 is illustrated to generally include a macerator housing 224, a chopper plate 225, a large wear plate 226, a pair of gaskets 227, an impeller 228, a small wearplate 229, a body 230, and a motor assembly 232.

The ancillary path 22 of the present teachings may be in the form of one or more fluid paths extending from the input port of the pump 206 to the discharge port 208. The pump 202 may be adapted to include the one or more fluid paths by drilling holes 302, 304, 306, 308, 310 in the appropriate pieces of the pump 206. Thus, when the pump 206 is assembled, there is a fluid pathway from the macerator housing 224 all the way to an opening 312 of the discharge port 208. In operation, the top of the macerator housing 224 is located within the adapter 218 such that when gray water is delivered to the pump 206 it will stand at the top of the macerator housing 224 until the pump 206 is turned on. However, with the ancillary path 220 in place, the gray water can bypass the impeller region of the pump 206 and flow directly out the discharge port 208. The holes 302, 304, 306, 308, 310 may be machined, stamped, or molded into the respective pieces during manufacture or may be drilled all at once after assembly of the pump 206 in complete.

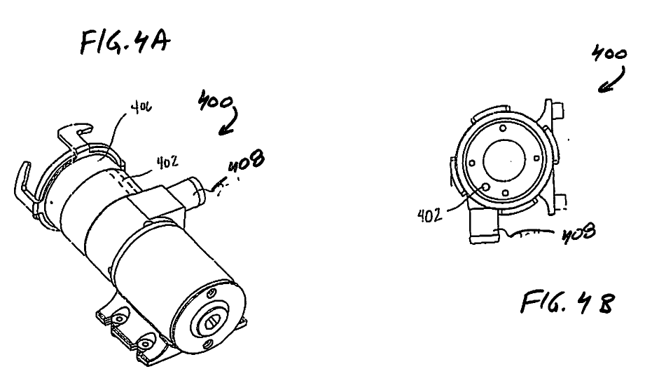

Turning to FIGS. 4A and 4B, alternative pump assembly 400 in accordance with the present teachings is illustrated. The pump assembly 400 has an integrally manufactured mating adapter 406. However, operation of the pump 400 will be understood to be substantially similar to the pump 400 of FIGS. 2 and 3 in that an ancillary path 402 is created within the housing of the pump 400 to provide a bypassing route for fluid to flow to the discharge port 408.

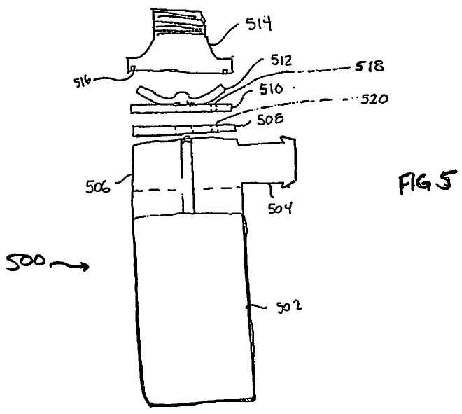

Turning to FIG. 5, an exploded view of yet another pump is illustrated and identified at reference character 500. This pump 500 has a different type adapter region 514 that typically is threaded. The wearplate. A chopper 512 sits above a wear plate 510 and some type of gasket or sealer 508 that, as an assembly, sit above a pump housing/impeller region 506 having a discharge port 504. The wearplate 510 has an opening so that chopped solids and fluids can be communicated to the impeller region 506. However, there are other openings 518 (and 520) that are created to provide an ancillary path to the discharge port 504 that allows fluid to flow out of the pump 500 even though the pump is turned off and the impeller is not spinning. These holes 518 and 520 are beneficially located within the region surrounded by a gasket 526 such that leakage of fluid out of the pump 500 is prevented.

Returning briefly to FIG. 2, when the pump 206 is turned off, the pressure at the head of the pump 206 forces the gray water through the ancillary path 2120 toward downstream the discharge port 208. However, when the pump 206 is turned on, the impeller 228 creates a high pressure downstream such that some of the fluid being forced out of the discharge port 208 actually travels up the ancillary path 220 in the upstream direction. This fluid operates to unclog the ancillary path 220 and, thereby, provide a self-cleaning function for this device.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A wastewater disposal system as described in the figures and text herein.

2. A macerator pump for a wastewater disposal system of a vehicle, the macerator pump comprising:
a housing;
an input port;
an output port;
a primary fluid path extending between the input port and the output port, the primary fluid path including an impeller region having an impeller driven by a motor, the primary fluid path being open when the motor is on and closed when the motor is off;
an ancillary fluid path extending between the input port and the output port, the ancillary fluid path being open independent of an operational state of the motor.

2. The macerator pump of claim 1, wherein the housing includes a sidewall, the ancillary fluid path extending through the sidewall.

3. The macerator pump of claim 2, further comprising a plurality of gaskets, the ancillary fluid path extending through the plurality of gaskets.

4. The macerator pump of claim 3, further comprising a pump body, the ancillary fluid path extending through the pump body.

5. A wastewater disposal system for a vehicle, the wastewater disposal system comprising:
a black water tank;
a gray water tank;
a macerator pump having a housing, an input port and an output port, the input port being in fluid communication with the black water tank and the gray water tank, the macerator pump defining a primary fluid path and an ancillary fluid path, the primary fluid path extending between the input port and the output port and including an impeller region having an impeller driven by a motor, the primary fluid path being open when the motor is on and closed when the motor is off, the ancillary fluid path extending between the input port and the output port, the ancillary fluid path being open independent of an operational state of the motor;
a first valve for selectively controlling the flow of gray water from the gray water tank to the input port of the macerator pump; and
a second valve for selectively controlling the flow of black water from the gray water tank to the input port of the macerator pump.

6. The wastewater disposal system of claim 5, wherein the housing includes a sidewall, the ancillary fluid path extending through the sidewall.

7. The wastewater disposal system of claim 6, wherein the pump further comprises a plurality of gaskets, the ancillary fluid path extending through the plurality of gaskets.

8. The wastewater disposal system of claim 7, wherein the pump further comprises a pump body, the ancillary fluid path extending through the pump body.

9. A method of disposing wastewater from a vehicle having a gray water tank and a black water tank, the method comprising:
providing a macerator pump having a housing, an input port and an output port, the input port being in fluid communication with the black water tank and the gray water tank, the macerator pump defining a primary fluid path, the primary fluid path extending between the input port and the output port and including an impeller region having an impeller driven by a motor, the primary fluid path being open when the motor is on and closed when the motor is off;
adapting the macerator pump to include an ancillary fluid path between the input port and the output port, the ancillary fluid path being continually open independent of an operational state of the motor;
selectively controlling the flow of gray water from the gray water tank to the input port to discharge gray water through the ancillary fluid path when the motor is off.

10. The method of disposing wastewater of claim 9, wherein the step of controlling the flow of gray water is done from within the vehicle.
